(19) United States
(12) Patent Application Publication
(10) Pub. No.: US 2017/0236483 A1
(43) Pub. Date: Aug. 17, 2017

(54) LIQUID CRYSTAL DISPLAY DRIVING DEVICE AND LIQUID CRYSTAL DISPLAY DRIVING METHOD

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Xingling GUO, Shenzhen, Guangdong (CN); Jinjie ZHOU, Shenzhen, Guangdong (CN); Jiehui QIN, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hube (CN)

(21) Appl. No.: 14/906,527

(22) PCT Filed: Sep. 11, 2015
(86) PCT No.: PCT/CN2015/089456

§ 371 Date: Jan. 20, 2016

(30) Foreign Application Priority Data
Aug. 20, 2015 (CN) 201510514459.8

(51) Int. Cl. G09G 3/36; H04N 13/04

(52) U.S. Cl. CPC G09G 3/3688; G09G 3/3607; G09G 3/3677; H04N 13/0438; G09G 2310/08; G09G 2320/0673

(57) ABSTRACT

The present disclosure discloses a liquid crystal display driving device, including a time sequence controller, a data and scan drivers, a liquid display panel and a programmable gamma circuit connected to the data driver. The time sequence controller is respectively connected to the data and scan drivers. The data driver coverts an image data to an analog voltage. The programmable gamma circuit outputs a reference voltage to the data driver and used to assign the reference voltage in real time. The reference voltage corrects the analog voltage so the data driver outputs a gray-level voltage to a liquid crystal unit opened by the scan driver to display an image frame or a black frame. It overcome a problem of overlapping a left-eye and right-eye image frames and at the same time greatly decreases a power consumption of a system. The present disclosure also discloses a liquid crystal display driving method.

### CROSS-REFERENCE TO RELATED APPLICATIONS

This application claims the priority of Chinese Patent Application No. 201510514459.8, entitled “liquid crystal display driving device and liquid crystal display driving method”, filed on Aug. 20, 2015, the disclosure of which is incorporated herein by reference in its entirety.

### FIELD OF THE INVENTION

The present disclosure relates to a liquid crystal display field, and more particularly to a liquid crystal display driving device and a liquid crystal display driving method.

### BACKGROUND OF THE INVENTION

With the development of liquid crystal display (LCD) technology, three-dimensional (3D) LCD technology is increasingly used in people's daily life. To increase an original resolution of frame, a frame of the image is divided into two image frames, which are corresponding to a left eye and a right eye and displayed alternatively. A left lens is opened and a right lens is closed to display the left-eye image frame. The right lens is opened and the left lens is closed to display the right-eye image frame. It is ensured that the left eye only sees the image frame corresponding to the left eye and the right eye only sees the image frame corresponding to the right eye. However, when the image frames of the left and right eyes are displayed alternatively, a problem of overlapping frames is easily is occurred. Thus, the received left-eye image includes the right-eye image frame and the received right-eye image includes the left-eye image frame, so the 3D image is error to affect a 3D display result.

To overcome the above-mentioned the problem of overlapping frames of the left and right eyes, a black frame insertion (BFI) technology is usually employed. Thus, after displaying the image frame of the left eye and before displaying the image frame of the right eye, or after displaying the image frame of right eye and before displaying the image frame of the left eye, inserting a black frame forms a refreshing sequence of a left-eye frame, a black frame, a right-eye frame and a black frame. Accordingly, the left eye receives the left-eye frame and the black frame and the right eye receives the right-eye frame and the black image. The black frames are overlapped and the black frame is a background so the 3D display result is not effected and the problem of overlapping frames is overcome.

A liquid crystal display driving system usually and mainly includes a time sequence controller, a gamma chip, a data driver and a scan driver, wherein the time sequence controller provides an image data signal and a time sequence control signal to the data driver and provides a time sequence signal to the scan driver. Currently, the BFI technology applied for a 3D liquid crystal display technology is implemented by controlling the time sequence controller to output the image data signal. Please refer to FIG. 1, a schematic diagram of BFI of a conventional liquid crystal display driving method is shown. As shown in FIG. 1, a frame refreshing frequency f is doubled to 2f. For example, the original refreshing frequency 120 Hz is increased to 240 Hz. One original image frame becomes one normal image frame and one black frame. Thus, the time sequence controller firstly outputs RGB data required by a first normal image frame, then outputs RGB data required by a first black frame, then outputs RGB data required by a second normal image frame, then outputs RGB data required by a second black image, and the processes are repeated accordingly. Apparently, in the conventional solution of implementing the BFI technology, the time sequence controller is required to provide the image data, whether the image frame or the black image. Therefore, the time sequence controller and data driver require a real-time full-volume data transmission. it results in consuming a lot of power and resources so the power cannot be saved.

### SUMMARY OF THE INVENTION

Regarding to the above-mentioned problem, the technical issue that the present disclosure solves is to provide a liquid crystal display driving device, which not only overcomes the problem of overlapping the left-eye and right-eye image frames in a 3D liquid crystal display but also decreases a power consumption of the liquid crystal display driving device.

The present disclosure also provides a liquid crystal display driving method.

To solve the foregoing technology problem, in one facet, the present disclosure provides the liquid crystal display driving device, comprising: a time sequence controller, a data driver, a scan driver and a liquid display panel, and the time sequence controller respectively connected to the data driver and the scan driver and outputting a control signal to the scan driver, wherein the liquid crystal display driving device further comprises a programmable gamma circuit, the programmable gamma circuit is connected to the data driver, the data driver coverts an image data to an analog voltage, the scan driver opens a liquid crystal unit of the liquid crystal display panel according to the control signal, the programmable gamma circuit outputs a reference voltage to the data driver and is used to assign the reference voltage in real time, and the reference voltage corrects the analog voltage so the data driver outputs a gray-level voltage to a liquid crystal unit, which is opened by the scan driver, and the liquid crystal display panel displays an image frame or a black frame.

Selectively, the programmable gamma circuit comprises a writing unit, and the writing unit is used to assign the reference voltage and is used to write a frame period length of the black frame.

Selectively, a working mode of the programmable gamma circuit comprises a default mode and a correction mode, when the programmable gamma circuit is at the default mode, the writing unit does not work, and when the programmable gamma circuit is at the correction mode, the writing unit works.

Selectively, when the programmable gamma circuit is at the default mode, the programmable gamma circuit assigns the reference voltage by a preset parameter.

Selectively, the liquid crystal display driving device further comprises a mode selector and the mode selector controls that the liquid crystal display driving device is at the default mode or the correction mode.

Selectively, when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

Selectively, the base voltage is a common electrode voltage of the liquid crystal display panel, when the reference voltage is equal to the common electrode voltage, the gray-level voltage outputted from the data driver does not drive the liquid crystal unit to overturn, so the liquid crystal display panel displays the black frame.

In another facet, the present disclosure also provides the liquid crystal display driving method, comprising:

(a) a time sequence controller outputting an image data to a data driver, a programmable gamma circuit transmitting a reference voltage to the data driver so the data driver normally outputs a gray-level voltage and a liquid crystal display panel displays an image frame; and

(b) after a frame period of the image frame is ended, the time sequence controller stopping transmitting the image data to the data driver, the programmable gamma circuit assigning the reference voltage to be equal to a base voltage so the liquid crystal display panel displays a black frame.

Selectively, the programmable gamma circuit comprises a writing unit and in the step (b), the programmable gamma circuit assigns the reference voltage by the writing unit.

Selectively, in the step (a), the writing unit does not work.

Selectively, a ratio of a frame period length of the black frame to a frame period length of the image frame is 1:2n, wherein, n represents an integer, which is larger than or equal to 0.

Selectively, a frame period length of the black frame is written by the programmable gamma circuit.

With comparison with the prior art, the present disclosure has following advantages. (1) The technology of the present disclosure employs the programmable gamma circuit to assign a reference voltage to be equal to a base voltage and the black frame is outputted, so a goal of FBI is achieved and the problem of overlapping the left-eye and right-eye frames is overcome. (2) The present disclosure uses the programmable gamma circuit to assign the reference voltage, and the time sequence controller does not need to transmit the image data to the data driver when the black image is required to output, so it is easy to be implemented and greatly decreased the power consumption of the liquid crystal display driving device.

### BRIEF DESCRIPTION OF THE DRAWINGS

In order to more clearly illustrate the embodiments of the present disclosure or prior art, the following figures will be described in the embodiments are briefly introduced. It is obvious that the drawings are merely some embodiments of the present disclosure, those of ordinary skill in this field can obtain other figures according to these figures without paying the premise.

FIG. 1 is a schematic diagram of BFI of a conventional liquid crystal display driving method;

FIG. 2 is a circuit schematic diagram showing that a liquid crystal display driving device of an embodiment of the present disclosure outputs an image frame;

FIG. 3 is a circuit schematic diagram showing that a liquid crystal display driving device of an embodiment of the present disclosure outputs a black frame;

FIG. 4 is a flow chart of a liquid crystal display driving method of an embodiment of the present disclosure;

FIG. 5 is a schematic diagram of BFI of the liquid crystal display driving method of a first embodiment of the present disclosure;

FIG. 6 is a schematic diagram of BFI of the liquid crystal display driving method of a second embodiment of the present disclosure; and

FIG. 7 is a schematic diagram of BFI of the liquid crystal display driving method of a third embodiment of the present disclosure.

### DETAILED DESCRIPTION OF THE PREFERRED EMBODIMENTS

Embodiments of the present disclosure are described in detail with the technical matters, structural features, achieved objects, and effects with reference to the accompanying drawings as follows. It is clear that the described embodiments are part of embodiments of the present disclosure, but not all embodiments. Based on the embodiments of the present disclosure, all other embodiments to those of ordinary skill in the premise of no creative efforts obtained, should be considered within the scope of protection of the present disclosure.

In addition, the following description of the embodiments refer to drawings and specific embodiments are examples of implementing the present disclosure. The terms mentioned by the present disclosure, such as “up”, “down”, “front”, “after”, “left”, “right”, “inside”, “outside”, “side” etc., are reference directions in according with the drawings. Therefore, the directional terms are used to clearly describe and understand the present disclosure, but does not teach or imply that the device or element limited in a specific direction and has a specific directional structure and operation. Thus, they are not explained to the limitations of the present disclosure.

In the description of the present disclosure, it should be understood that the term “install”, “joint”, “connect” should be explained broadly unless a definite rule and limitation are addressed. For example, it is can be connected securely, connected separately, connected integratedly, connected mechanically, connected directly, connected indirectly through an intermediary, or connected between insides of two elements. Person skilled in the art can understand the real meanings of the terms based on the particular condition.

In addition, in the description of the present disclosure, the meaning of “multiple” is “two” or “more than two”, unless other definition is addressed. If the term “step” is appeared in the specification of the present disclosure, it not only represents an individual step but also includes an expected function caused by implementing the step when the step and other steps are not distinguished obviously. Furthermore, a symbol “˜” represents a number range, which includes a minimum number and a maximum written in front and rear of the symbol “˜”. In the drawings, the similar or the same units are marked by the same reference number.

Please refer to FIG. 2, an embodiment of the present disclosure provides a liquid crystal display driving device. As shown in FIG. 2, the liquid crystal display driving device comprises: a time sequence controller 10, a data driver 20, a scan driver 30, a programmable gamma circuit 40 and a liquid crystal display panel 50.

The time sequence controller 10 is respectively connected to the data driver 20 and the scan driver 30, and is used to output an image data and a control signal to the data scanner 20 and to output a control signal to the scan driver 30. The data driver 20 is electrically connected to the programmable gamma circuit 40 and the liquid crystal display panel 50, and is used to output a gray-level voltage to a liquid crystal unit of the liquid crystal display panel 50. The gray-level voltage is used to drive multiple liquid crystals to overturn. The scan driver 30 is electrically connected to the liquid crystal display panel 50, and is used to control the liquid crystal unit 51 of the liquid crystal display panel 50 to turn on or off. The programmable gamma circuit 40 is electrically connected to the data driver 20, and is used to output a reference voltage to the data driver 20 and to assign the reference voltage in real time.

In the embodiment of the present disclosure, a function of the programmable gamma circuit 40 is to set the reference voltage according to a gamma curve required by the liquid crystal display panel 50 and the reference voltage is used as a reference of a gray-scale display. Particularly, the programmable gamma circuit 40 fits the gamma curve required by the liquid crystal display panel 50 according to the gray scales and a transmittance curve, and further combines a voltage to transmittance curve of liquid crystal material to calculate a corresponding reference voltage of each gray level. It can be understood that according to user's needs, the programmable gamma circuit 40 can directly assign the reference voltage without following the above-mentioned calculating process, and the reference voltage may be any value according to requirement. For example, the outputted reference voltage is directly assigned to be equal to a preset base voltage Vcom, so the outputted gray-level voltage does not drive the liquid crystals to overturn and a black frame is outputted. Wherein, the base voltage Vcom is a common electrode voltage of the liquid crystal display panel 50.

In the embodiment of the present disclosure, the programmable gamma circuit 40 includes a real-time-control writing unit 41. Particularly, the writing unit 41 is a register writing unit. The programmable gamma circuit 40 can work under two modes including a default mode and a correction mode. When the programmable gamma circuit 40 is at the default mode, the writing unit 41 does not work so the programmable gamma circuit 40 automatically assigns a preset default parameter as the reference voltage. When the programmable gamma circuit 40 is at the correction mode, the writing unit 41 works to assign a content to be corrected. For example, reassigning the reference voltage according to the base voltage Vcom makes that the reference voltage outputted from the programmable gamma circuit 40 is equal to the base voltage Vcom, and a written frame is a black frame accordingly. Here, the base voltage Vcom is the common electrode voltage of the liquid crystal display panel 50. When no content is needed to be corrected, the programmable gamma circuit 40 works at the default mode.

After the programmable gamma circuit 40 assigns the reference voltage, multiple voltages are generated by a voltage dividing circuit (not shown in FIG. 2) and those voltages (not shown in FIG. 2) are amplified by multiple output buffers and outputted to the data driver 20 to correct an analog voltage of the data driver 20, wherein the analog voltage is converted from the image data. The data driver 20 outputs the gray-level voltage to the liquid crystal unit 51 of the liquid crystal display panel 50 to drive the liquid crystals to overturn to display the image frame. When the reference voltage is equal to the base voltage Vcom, the outputted gray-level voltage cannot drive the liquid crystal unit 51 to overturn so the black frame is outputted accordingly.

In the embodiment of the present disclosure, an operation process of the liquid crystal display driving device is described as follows.

Please also refer to FIG. 2, in the embodiment of the present disclosure, the time sequence controller 10 outputs the control signal to the scan driver 30 and the scan driver 30 opens the liquid crystal unit 51 of the liquid crystal display panel 50. At the time, the time sequence controller 10 transmits the image data to the data driver 20 and the data driver 20 converts the image data to a corresponding analog voltage. At the same time, the programmable gamma circuit 40 transmits the reference voltage to the data driver 20 to correct the analog voltage. An normal gray-level voltage is outputted to the liquid crystal unit 51, which is opened by the scan driver 30, so the liquid crystal display panel 50 displays the image frame.

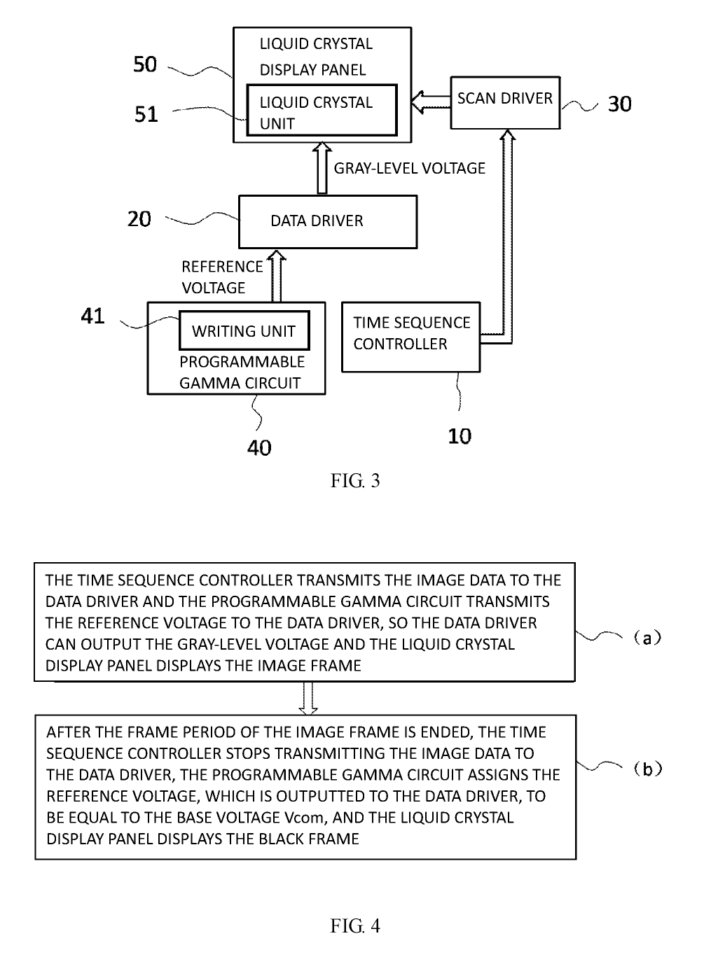

Please refer to FIG. 3. FIG. 3 is a circuit schematic diagram showing that a liquid crystal display driving device of an embodiment of the present disclosure outputs a black frame. As shown in the diagram, when a frame period of the image frame is ended, the time sequence controller 10 stops transmitting the image data to the data driver 20. The programmable gamma circuit 40 assigns the reference voltage by the writing unit 41, so the reference voltage outputted to the data driver 20 is equal to the base voltage Vcom. At the time, the obtained gray0level voltage is outputted to the liquid crystal unit 51, which is opened by the scan driver 30, but the liquid crystals are not overturned. The liquid crystal display panel 50 displays the black frame accordingly.

After a frame period of the black frame is ended, the process of outputting the image frame shown in FIG. 2 is repeated. The time sequence controller 10 outputs the image data to the data driver 20 again until the frame period of the image data is ended, the process of outputting the black frame shown in FIG. 3 is executed. The processes are repeated accordingly so the liquid crystal display driving device completes the liquid crystal display driving process of the BFI.

In the embodiment of the present disclosure, the writing unit 41 is also used to write a frame period length of the black frame. The frame period length of the black frame is 1/(2n) and a frame period length of the image frame is 1/(2nf), wherein f represents a refreshing frequency, n represents an integer, which is larger than or equal to 0. Thus, the frame period length of the black frame may be shorter than that of the image frame.

According to other requirements, under the correction mode of the programmable gamma circuit 40, any frame period length for the black frame can be written.

In the embodiment of the present disclosure, the liquid crystal display device also comprises a mode selector (not shown in the drawing). The liquid crystal display device is controlled to be at the default mode or the correction mode by the mode selector.

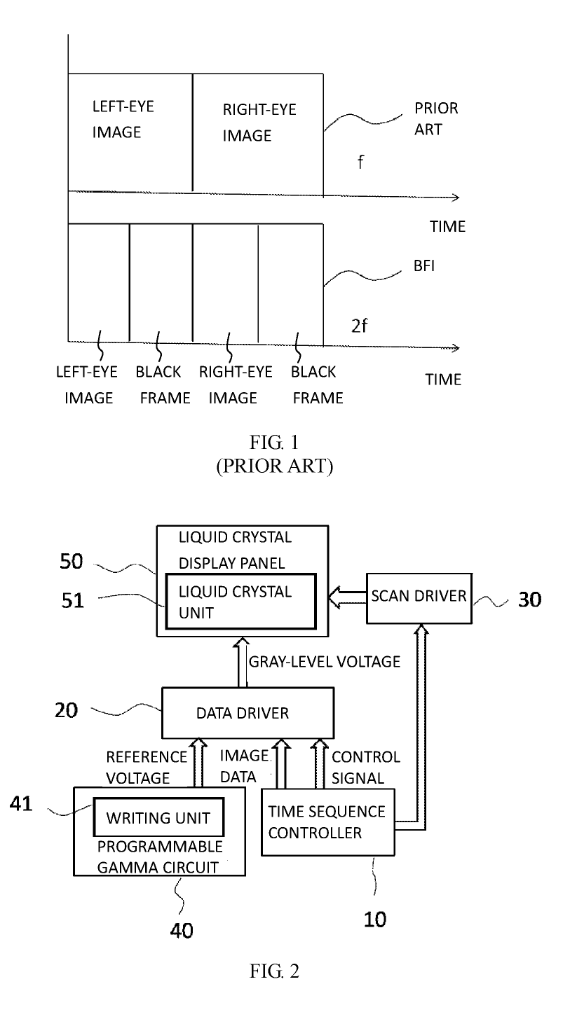

Please refer to FIG. 4. FIG. 4 is a flow chart of a liquid crystal display driving method of an embodiment of the present disclosure. FIG. 4 shows the liquid crystal display driving method which is used in the liquid crystal display driving device shown in FIG. 1 and FIG. 2. The liquid crystal display driving method at least comprises following steps.

(a) The time sequence controller transmits the image data to the data driver and the programmable gamma circuit transmits the reference voltage to the data driver, so the data driver can output the gray-level voltage and the liquid crystal display panel displays the image frame.

(b) After the frame period of the image frame is ended, the time sequence controller stops transmitting the image data to the data driver, the programmable gamma circuit assigns the reference voltage, which is outputted to the data driver, to be equal to the base voltage Vcom, and the liquid crystal display panel displays the black frame.

After the frame period of the black frame in the step of (b) is ended, the step (a) is repeated. The time sequence controller transmits the image data to the data driver again until the frame period of the image data is ended, the step (b) is executed and the processes are repeated accordingly.

In the embodiment of the present disclosure, the function of the programmable gamma circuit is setting the reference voltage according to a gamma curve required by the liquid crystal display panel and the reference voltage is used as a reference of a gray-scale display. Particularly, the programmable gamma circuit fits the gamma curve required by the liquid crystal display panel according to the gray scales and a transmittance curve, and further combines a voltage to transmittance curve of liquid crystal material to calculate a corresponding reference voltage of each gray-level. in addition, the programmable gamma circuit can assign the reference voltage. It can be understood that according to user's needs, the programmable gamma circuit can directly assign the reference voltage without following the above-mentioned calculating process so the reference voltage may be any value according to requirement. For example, the outputted reference voltage is directly assigned to be equal to a preset base voltage Vcom.

In the embodiment of the present disclosure, the programmable gamma circuit includes a real-time-control writing unit. The programmable gamma circuit can work under two modes including the default mode and the correction mode. When the programmable gamma circuit is at the default mode, the writing unit does not work so the programmable gamma circuit automatically assigns a preset default parameter as the reference voltage. When the programmable gamma circuit is at the correction mode, the writing unit works to assign a content to be corrected. For example, reassigning the reference voltage according to the base voltage Vcom makes that the reference voltage outputted from the programmable gamma circuit is equal to the base voltage Vcom, and a written frame is a black frame accordingly. When no content is needed to be corrected, the programmable gamma circuit 40 works at the default mode.

After the programmable gamma circuit assigns the reference voltage, the multiple voltages are generated by the voltage dividing circuit and those voltages are amplified by the output buffers and outputted to the data driver to correct an analog voltage converted from the image data. The data driver outputs the gray-level voltage to the liquid crystal unit 51 of the liquid crystal display panel, which is opened by the scan driver, to drive the liquid crystals to overturn to display the image frame. When the reference voltage is equal to the base voltage Vcom, and the outputted gray-level voltage cannot drive the liquid crystal unit 51 to overturn so the black frame is outputted accordingly.

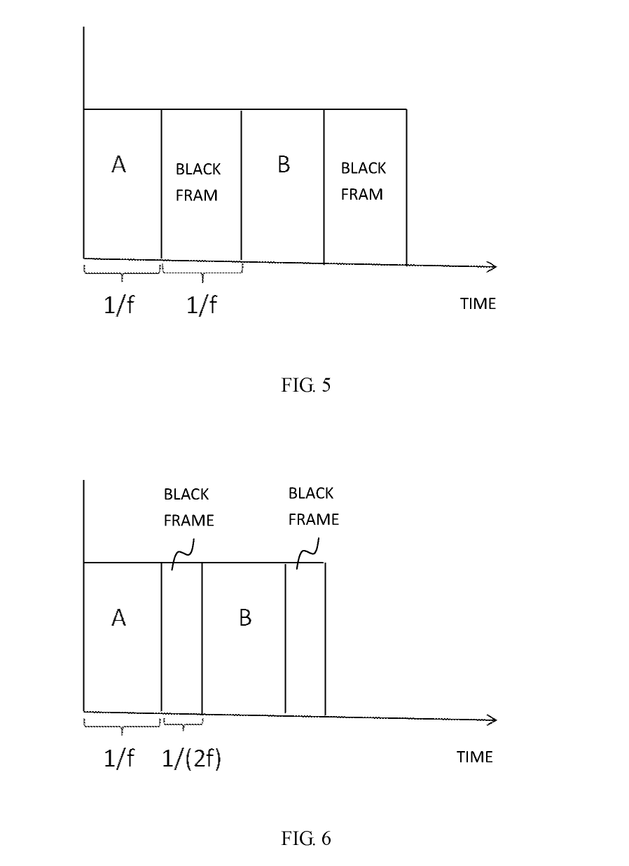

Please refer to FIG. 5. FIG. 5 is a schematic diagram of the BFI of the liquid crystal display driving method of a first embodiment of the present disclosure. In the present disclosure, the liquid crystal display driving method particularly comprises:

Regarding to an image frame A, the scan driver opens the liquid crystal units on a first line, the time sequence controller starts outputting a first-line data corresponding to the image frame A to the data driver. After the data driver received the first-line data, the first-line data is latched in a latch and prepared for the gray-level voltage conversion.

The programmable gamma circuit works at the default mode, so the writing unit does not work and the programmable gamma circuit automatically assigns a preset default parameter as the reference voltage and obtains the reference voltage corresponding to each gray level through the voltage dividing circuit and the output buffer. For example, if the liquid crystal display panel has 256 gray levels, the programmable gamma circuit outputs 256 referenced voltages to the data driver correspondingly.

According to the corresponding reference voltages of the liquid crystal units 51 on the first line and the corresponding data in the data latch of the liquid crystal units 51, the data driver outputs corresponding gray-level voltages to the liquid crystal units 51 on the first line, which is opened by the scan driver to drive the liquid crystals of the liquid crystal units 51 to overturn. The liquid crystal units 51 on the first line are refreshed.

When scan driver opens the liquid crystal units 51 on a second line, the above-mentioned process is repeated. A frame period of the image frame A is ended until the liquid crystal units corresponding to the image frame A are refreshed and the image frame A is displayed completely.

After the frame period A of the image frame A is ended, the time sequence controller stops outputting data signal of the image frame to the data driver.

When entering a frame period of a black frame, the scan driver opens the liquid crystal units 51 on the first line. The programmable gamma circuit works at the correction mode, so the writing unit works to assign the reference voltages of the liquid crystal units 51 to be equal to the base voltage Vcom and to output the reference voltages to the data driver. At the time, the data driver uses the reference voltages as the gray-level voltages and outputs the gray-level voltages to the liquid crystal units 51 on the first line, which is opened by the scan driver so the liquid crystal units 51 on the first line of the black frame are completely refreshed. Since the lines of the black frame are the same, before the frame period of the black frame is ended, the programmable gamma circuit outputs the above-mentioned reference voltages, until the frame period of the black frame is ended. Since the reference voltage is equal to the base voltage Vcom, the liquid crystals are not overturned. Therefore, the black frame is displayed to completely refresh the black frame.

Next to enter a frame period of an image frame B, the above-mentioned processes of refreshing the image frame A and the black frame are repeated in sequence. The processes The processes are repeated accordingly, so a process of the BFI of the liquid crystal display panel is accomplished.

In the present embodiment, if the corresponding base voltages Vcom of the black frames after the present black frame are equal to the base voltage Vcom of the present black frame, the base voltage Vcom is not reset. At the time, during the frame period of each black frame after the present disclosure, the programmable gamma circuit can work at the default mode.

In the present embodiment, the frame period length of the image frame is equal to that of the black frame. If f represents the refreshing frequency, the frame period length of the black frame=the frame period length of the image frame=1/f. For example, if f=240, the frame period length of the black frame=the frame period length of the image frame= 1/240.

In the present embodiment, during the frame period length of the black frame, the time sequence controller does not need to transmit the image data to the data driver, so an operation process is simplified. It is easy to be implemented and greatly decreased the power consumption of the liquid crystal display driving device. in addition, since the refreshing process of the black frame only requires to write the reference voltage once, a work-loading of the programmable gamma circuit can be decreased and simplify an operation process of driving the liquid crystal display.

Please refer to FIG. 6. FIG. 6 is a schematic diagram of the BFI of the liquid crystal display driving method of a second embodiment of the present disclosure. The liquid crystal display driving method of the present embodiment is similar to that of FIG. 5 and a difference is that a frame period length of a black frame of the present embodiment is ½ of that of the first embodiment but a frame period length of an image frame is not changed. Thus, the frame period length of the black frame=½ of the frame period length of the image frame=1/(2f), wherein f represents the refreshing frequency. Accordingly, a longer black frame display period causes a problem of brightness of the image frame occurred and the problem can be solved.

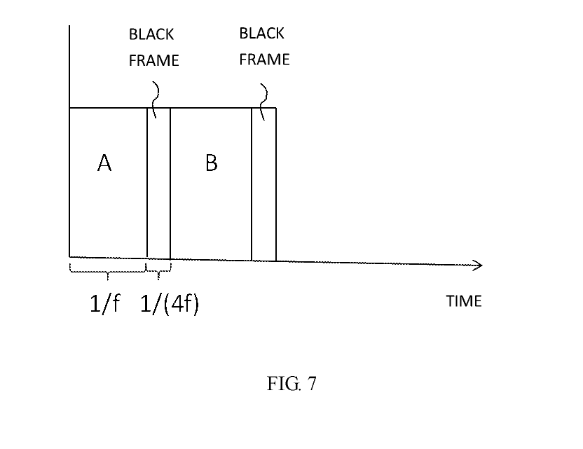

Please refer to FIG. 7. FIG. 7 is a schematic diagram of BFI of the liquid crystal display driving method of a third embodiment of the present disclosure. The liquid crystal display driving method of the present embodiment is similar to that of FIG. 5 and a difference is that a frame period length of a black frame of the present embodiment is ¼ of that of the first embodiment but a frame period length of an image frame is not changed. Thus, the frame period length of the black frame=¼ of the frame period length of the image frame=1/(22f), wherein f represents the refreshing frequency. Accordingly, a longer black frame display period causes a problem of brightness of the image frame occurred and the problem can be solved.

And so on and so forth, in the embodiments of the present disclosure, the frame period length of the black frame=1/(2n) of the frame period length of the image frame=1/(2nf), wherein, n represents an integer, which is larger than or equal to 0. Thus, the frame period length of the black frame can be set to be shorter than the frame period length of the image frame.

According to other requirements, under the correction mode of the programmable gamma circuit, any frame period length for the black frame can be written.

In the description of the present specification, the reference term “an embodiment”, “some embodiments”, “example”, “particular example” or “some examples” etc. means that particular characteristic, structure, material or feature of the embodiment and example are combined and at least one embodiment or example of the present disclosure includes the combination. In the present specification, a schematic representation of the above-mentioned term does not necessarily mean a schematic representation of the same embodiment or example. And, the described particular characteristic, structure, material or feature can be combined by a proper way in any one embodiment or multiple embodiments.

The above embodiments of the present disclosure are not used to limit the claims of this disclosure. Any use of the content in the specification or in the drawings of the present disclosure which produces equivalent structures or equivalent processes, or directly or indirectly used in other related technical fields is still covered by the claims in the present disclosure.

What is claimed is:

1. A liquid crystal display device, comprising: a time sequence controller, a data driver, a scan driver and a liquid display panel, and the time sequence controller respectively connected to the data driver and the scan driver and outputting a control signal to the scan driver, wherein the liquid crystal display driving device further comprises a programmable gamma circuit, the programmable gamma circuit is connected to the data driver, the data driver coverts an image data to an analog voltage, the scan driver opens a liquid crystal unit of the liquid crystal display panel according to the control signal, the programmable gamma circuit outputs a reference voltage to the data driver and is used to assign the reference voltage in real time, and the reference voltage corrects the analog voltage so the data driver outputs a gray-level voltage to a liquid crystal unit, which is opened by the scan driver, and the liquid crystal display panel displays an image frame or a black frame.

2. The liquid crystal display driving device according to claim 1, wherein, the programmable gamma circuit comprises a writing unit, and the writing unit is used to assign the reference voltage and is used to write a frame period length of the black frame.

3. The liquid crystal display driving device according to claim 2, wherein a working mode of the programmable gamma circuit comprises a default mode and a correction mode, when the programmable gamma circuit is at the default mode, the writing unit does not work, and when the programmable gamma circuit is at the correction mode, the writing unit works.

4. The liquid crystal display driving device according to claim 3, wherein when the programmable gamma circuit is at the default mode, the programmable gamma circuit assigns the reference voltage by a preset parameter.

5. The liquid crystal display driving device according to claim 3, wherein the liquid crystal display driving device further comprises a mode selector and the mode selector controls that the liquid crystal display driving device is at the default mode or the correction mode.

6. The liquid crystal display driving device according to claim 1, wherein when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

7. The liquid crystal display driving device according to claim 2, wherein when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

8. The liquid crystal display driving device according to claim 3, wherein when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

9. The liquid crystal display driving device according to claim 4, wherein when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

10. The liquid crystal display driving device according to claim 5, wherein when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

11. The liquid crystal display driving device according to claim 6, wherein when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

12. The liquid crystal display driving device according to claim 7, wherein when the data driver outputs the gray-level voltage to the liquid crystal unit, which is opened by the scan driver, to drive multiple liquid crystals of the liquid crystal unit to overturn, so the liquid crystal display panel displays the image frame; and when the gray-level voltage outputted from the data driver outputs is equal to a base voltage, the gray-level voltage is outputted to the liquid crystal unit, which is opened by the scan driver, the liquid crystals of the liquid crystal unit are not overturned so the liquid crystal display panel displays the black frame.

13. A liquid crystal display driving method, comprising:
(a) a time sequence controller outputting an image data to a data driver, a programmable gamma circuit transmitting a reference voltage to the data driver so the data driver normally outputs a gray-level voltage and a liquid crystal display panel displays an image frame; and
(b) after a frame period of the image frame is ended, the time sequence controller stopping transmitting the image data to the data driver, the programmable gamma circuit assigning the reference voltage to be equal to a base voltage so the liquid crystal display panel displays a black frame.

14. The method according to claim 13, wherein the programmable gamma circuit comprises a writing unit and in the step (b), the programmable gamma circuit assigns the reference voltage by the writing unit.

15. The method according to claim 14, wherein in the step (a), the writing unit does not work.

16. The method according to claim 15, wherein a ratio of a frame period length of the black frame to a frame period length of the image frame is 1:2n, wherein, n represents an integer, which is larger than or equal to 0.

17. The method according to claim 13, wherein a frame period length of the black frame is written by the programmable gamma circuit.

18. The method according to claim 14, wherein a frame period length of the black frame is written by the programmable gamma circuit.

19. The method according to claim 15, wherein a frame period length of the black frame is written by the programmable gamma circuit.

20. The method according to claim 16, wherein the frame period length of the black frame is written by the programmable gamma circuit.
